(19) United States
(12) Patent Application Publication
(10) Pub. No.: US 2004/0030789 A1
(43) Pub. Date: Feb. 12, 2004

(54) System and method for testing a protocol

(75) Inventors: Arun P. Gupta, San Jose, CA (US); Ramash Babu Mandava, San Jose, CA (US)

Correspondence Address: Finnegan, Henderson, Farabow,, Garrett & Dunner, L.L.P., 1300 I Street, N.W., Washington, DC, 20005-3315, US

(73) Assignee: Sun Microsystems, Inc..

(21) Appl. No.: 10/212,243

(22) Filed: Aug. 6, 2002

(51) Int. Cl. G06F 15/16

(52) U.S. Cl. 709/230; 709/203

(57) ABSTRACT

Methods and systems consistent with the present invention provide for testing a protocol for transmitting data between a first device and a second device. The first device sends a set of data to both a data controller and the second device. The data controller receives the set of data sent by the first device. The second device also receives the set of data sent by the first device. The second device then sends the data received from the first device to the data controller. The data controller sends the set of data received from the first device to a data comparator. The data controller then sends the set of data received from the second device to the data comparator. The data comparator compares both sets of data to determine if the transmission was accurate

### DESCRIPTION OF THE INVENTION

### FIELD OF THE INVENTION

This invention relates generally to Internet protocols and, more particularly, to systems and methods for testing such protocols.

### BACKGROUND OF THE INVENTION

Computer software applications for execution in connection with servers typically utilize a client-server architecture, as is illustrated in FIG. 1. As shown, user requests 102 for data, for example, are sent by a client 100 to a server 104. The server 104 will present the requested data as server responses 106 to the client 100. Client 100 and server 104 may represent processes. The client may be active in a first computer system, and the server may be active in a second computer system. The client and server may communicate with each other over a communication medium, thus providing distributed functionality and permitting multiple clients to take advantage of the data of the server.

Clients and servers on the Internet or World Wide Web (Web) may communicate using functionality provided, for example, by Hypertext Transfer Protocol (HTTP). The Web includes all the servers adhering to this standard which are accessible to clients via Uniform Resource Locators (URL's). In this context, the process associated with client 100 is called a browser, which establishes a connection with the process associated with server 104, called a Web server. Protocols other than HTTP may also be used. Another exemplary protocol is Simple Mail Transfer Protocol (SMTP), used in many e-mail systems.

Generally, a protocol is any format for transmitting data between two devices, such as between client 100 and server 104. The protocol may determine, for example, the type of error checking used, data compression method, and/or indicators for determining when a message has been sent and/or received, or any other information facilitating data transmission between two devices.

Development of a new protocol requires that the protocol be tested to ensure that the data is properly transmitted. Protocols may be tested to determine if the data itself is being transmitted properly. For example, if the data sent is the integer “7”, properly received data will also be “7.” Protocols may also be tested to determine if the data is being transmitted properly by type, such as integer, string, or other data type. Further, protocols may also be tested to determine if other protocol procedures are working properly, such as error correction or data correction. Thus, protocol testing may be complex and time-consuming.

### SUMMARY OF THE INVENTION

It is therefore desirable to have a method or system that permits efficient testing of developed protocols to ensure that data is properly transmitted.

Methods and systems consistent with the present invention facilitate testing a protocol for transmitting data between a first device and a second device. The first device sends a set of data to both a data controller and the second device. The data controller receives the set of data sent by the first device. The second device also receives the set of data sent by the first device. The second device then sends the data received from the first device to the data controller. The data controller first sends the set of data received from the first device to a data comparator. The data controller then sends the set of data received from the second device to the data comparator. The data comparator compares both sets of data to determine if the transmission was accurate.

Additional features of the invention will be set forth in part in the description which follows, and in part will be obvious from the description, or may be learned by practice of the invention. It is to be understood that both the foregoing general description and the following detailed description are exemplary and explanatory only and are not restrictive of the invention as claimed.

### BRIEF DESCRIPTION OF THE DRAWINGS

The accompanying drawings, which are incorporated in and constitute a part of this specification, illustrate several implementations of the invention, and, together with the description, serve to explain the principles of the invention. In the Figures:

FIG. 1 illustrates an exemplary client-server architecture;

FIG. 2 illustrates an exemplary protocol testing system, consistent with the present invention; and

FIG. 3 is a flow diagram that illustrates a method for testing a protocol, consistent with the present invention.

### DETAILED DESCRIPTION

Methods and systems consistent with the present invention facilitate efficient testing of developed protocols to ensure proper transmission of data. For example, consider the development of an application program interface (API) for invoking functions over the Internet using XML-based remote procedure calls. Among other things, the API may define a serialization protocol for data transmission. For example, the serialization protocol may involve converting data to a particular format at the client, transferring the data via HTTP or SMTP standards, and then deserializing or converting back the data at the server for interpretation. The serialization protocol may permit transfer of multiple types of data, including simple data types, such as Boolean, character, or string types, or complex data types, such as data structures and/or arrays comprising multiple simple data types. In order to ensure proper functioning of the API, it is necessary to ensure that the defined serialization protocol transfers each data type, as well as the data itself, properly.

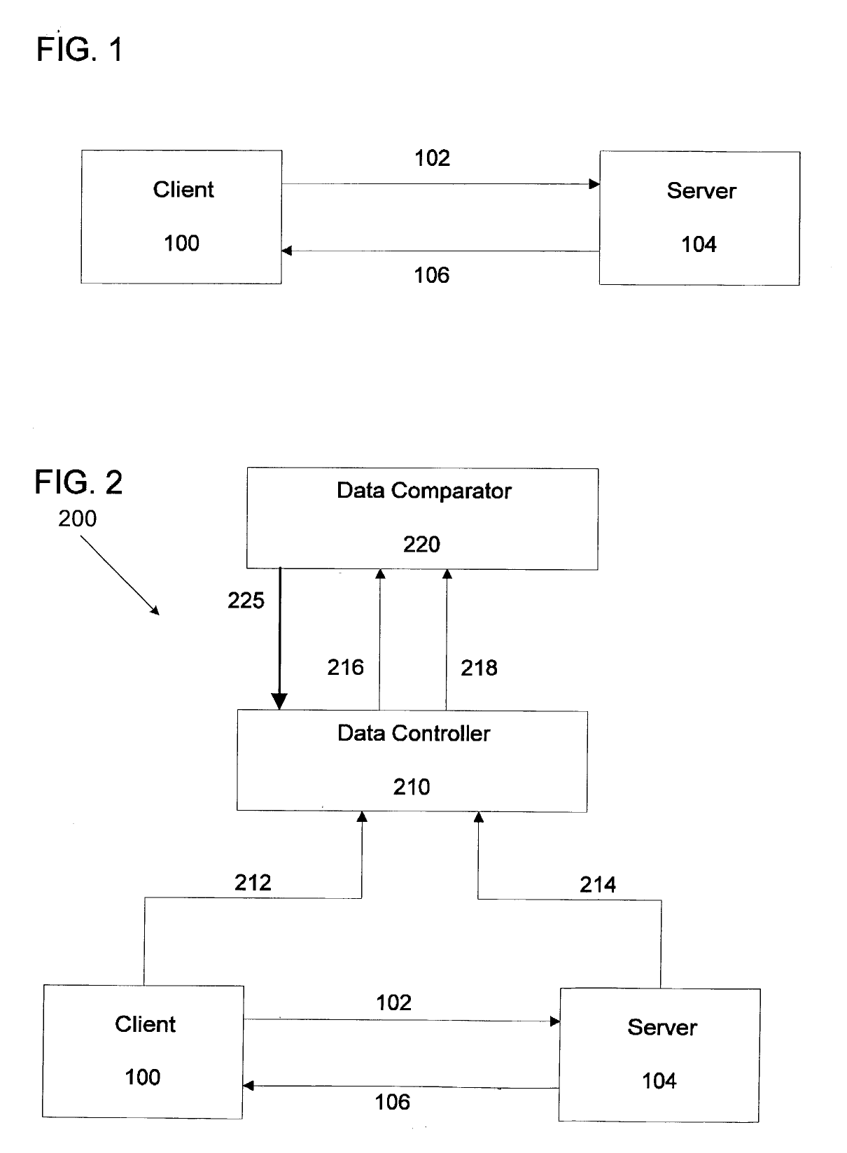

FIG. 2 illustrates a protocol testing system 200 consistent with the present invention. Protocol testing system 200 includes two devices, a client 100 and a server 104. Protocol testing system 200 also includes a data controller 210 and a data comparator 220. Client 100 sends a user request 102 for data to server 104. Server 104 generates a set of data in response to the request and sends the set of data 214 to data controller 210. Server 104 also sends the requested data as a server response 106 to client 100 using the protocol being tested, as described with respect to FIG. 1. When client 100 receives the server response 106, client 100 then sends the received set of data 212 to data controller 210.

Data controller 210 receives and manages data transmitted according to the protocol to be tested and may be implemented as a Java class. In addition to receiving transmitted data, data controller 210 may receive a parameter indicating an identification of where the data is being received from. For example, the parameter may include a string indicating “client” or “server.” Data controller then forwards the server data 218 and the client data 216 to data comparator 220, using any known data-transfer protocol. Server data 218 may be forwarded first to data comparator 220, because that data has not been influenced by the protocol to be tested.

Data comparator 220 may be implemented using any known comparison logic, such as a for-loop for comparing each element of data in the set. After data comparator 220 has received data associated with server 104 (server data 218) and client 100 (client data 216), data comparator 220 compares the data, for example, determining if the data types match as well as the data itself. Data comparator 220 reports the result 225 of the comparison to data controller 210. Data controller 210 may forward result 225 to either client 100, server 104, or both.

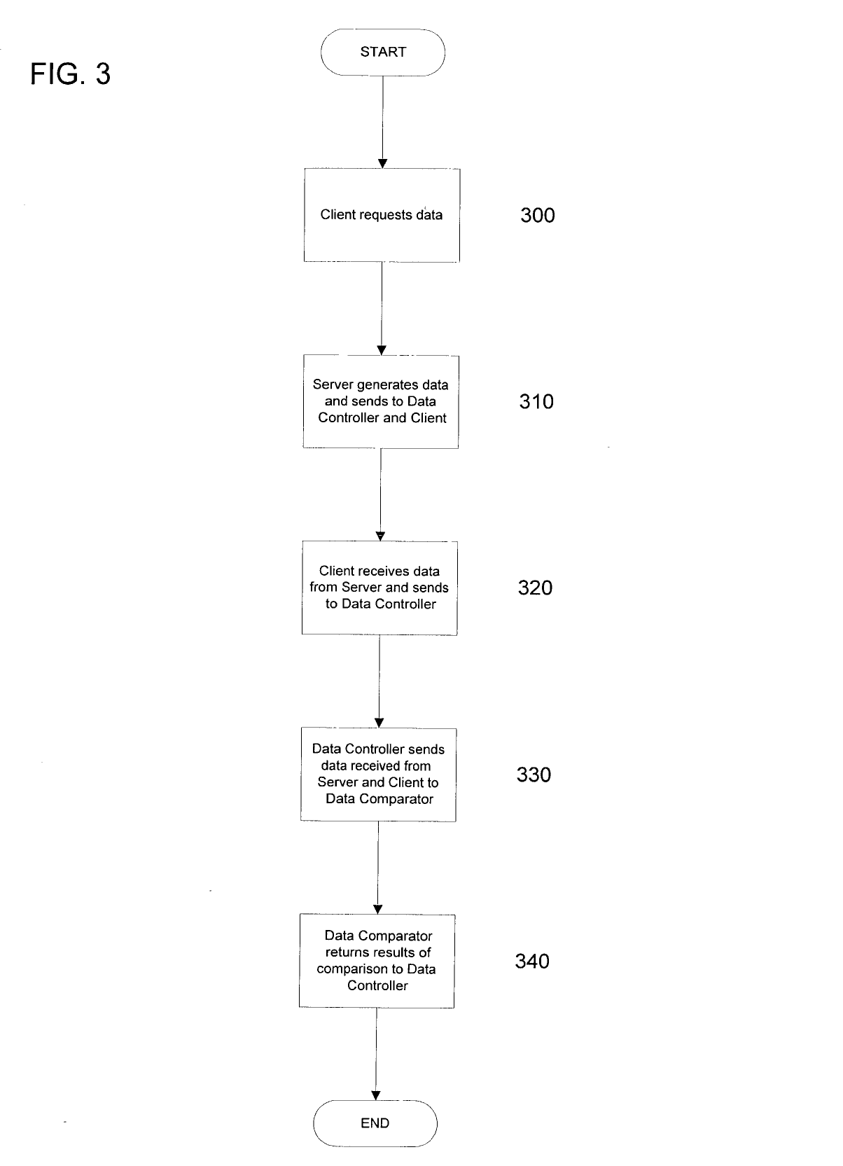

FIG. 3 is a flow diagram illustrating a method for testing a protocol, consistent with the present invention. First, client 100 sends a user request for data (step 300). Server 104 generates the requested data and sends the data to data controller 210 and client 100 (step 310). Server 104 identifies itself prior to sending the data to data controller 210. After the initial identification, data controller 210 is aware of any data received from server 104. Server 104 sends the same data to both data controller 210 and client 100. After client 100 receives the data from server 104, client 100 sends the data to data controller 210 (step 320). Similarly, prior to sending data to data controller 210, client 100 identifies itself.

Data controller 210 forwards the data received from client 100 and server 104 to data comparator 220 (step 330). In particular, data controller 210 first sends data received from the server 104 and then sends data received from the client 100. In one embodiment, data controller 210 sends the data received from server 104 prior to server 104 sending the data to client 100.

Data comparator 220 first receives data from server 104. After receiving data from client 100, data comparator 220 compares the data received from the client 100 to the data received from the server 104, and returns the results of the comparison to data controller 210 (step 340). The comparison may be made using any known comparison method. Further, the comparison may compare both the type of data sent as well as the data itself. For example, consider a simple data structure including two data types, such as structure EmployeeData, including a string EmployeeName and an long integer EmployeeSSN. In one structure EmployeeData, the EmployeeName include “John Smith” and the EmployeeSSN includes “0000000000”. Data comparator 220 will determine whether the data types, namely string and long integer, are correct, as well as the data itself. The results of the comparison may indicate any mismatch of data type of data. For example, the results may indicate a mismatch of data for EmployeeName. Data comparator 220 sends the results to data controller 210, which may report the results to either server 104, client 100, or both. If the data is transmitted properly, the results will be a match, indicating that the protocol worked properly.

Although the above description is directed toward server 104 sending information to client 100, methods and systems consistent with the present invention may be used for client 100 sending information to server 104. In this embodiment, client 100 sends data to data controller 210 and server 104. After server 104 receives the data from client 100, server 104 sends the data to data controller 210. As in the previous embodiment, data controller 210 forwards the data received from server 104 and client 100 to data comparator 220. Data comparator 220 compares the data and returns the results of the comparison to data controller 210.

The above-noted features and other aspects and principles of the present invention may be implemented in various system or network environments to provide tools for testing developed protocols. Such environments and applications may be specifically constructed for performing various processes and operations of the invention or they may include a general purpose computer or computing platform selectively activated or reconfigured by program code to provide the necessary functionality. The processes disclosed herein are not inherently related to any particular computer or apparatus, and may be implemented by a suitable combination of hardware, software, and/or firmware. For example, various general purpose machines may be used with programs written in accordance with the teachings of the invention, or it may be more convenient to construct a specialized apparatus or system to perform the required methods and techniques. The present invention also relate to computer readable media that include program instruction or program code for performing various computer-implemented operations based on the methods and processes of the invention. The media and program instructions may be those specifically designed and constructed for the purposes of the invention, or they may be of the kind well-known and available to those having skill in the computer software arts. Examples of program instructions include both machine code, such as produced by a compiler, and files containing a high level code that can be executed by the computer using an interpreter.

Other implementations of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for testing a developed protocol for transmitting data between a first device and a second device, the method comprising:
sending, by the first device, a set of data to a data controller using a known protocol;
sending, by the first device, a set of data to the second device using the developed protocol;
receiving, at the data controller, the set of data sent by the first device;
receiving, at the second device, the set of data sent by the first device;
sending to the data controller using the known protocol, by the second device, the set of data received from the first device;
sending, by the data controller, the set of data sent by the first device to a data comparator;
sending, by the data controller, the set of data sent by the second device to the data comparator; and
comparing, by the data comparator, of the set of data sent by the first device with the set of data sent by the second device.

2. The method of claim 1, further comprising:
providing results of the comparing step to the data controller.

3. The method of claim 2, further comprising:
providing, by the data controller, the results to at least one of the first device and the second device.

4. A system for testing a developed protocol, the system comprising:
a first device for sending a request for data and receiving a response to the request for data;
a second device for receiving and responding to the request for data;
a data controller for receiving data from the first device and the second device and forwarding the received data; and
a data comparator for receiving and comparing the forwarded data.

5. The system of claim 4, wherein the request for data and the response to the request for data are transmitted using the developed protocol.

6. The system of claim 4, wherein the data received by the data controller from the first device and the second device and the forwarded data are transmitted using a known protocol.

7. The system of claim 4, wherein the data comparator sends results of the comparison to the data controller.

8. The system of claim 4, wherein the data controller also receives one or more parameters identifying a source of the received data.

9. The system of claim 4, wherein the first device is a client and the second device is a server.

10. The system of claim 4, wherein the first device is a server and the second device is a client.

11. A method for testing a developed protocol based on data transmitted from a first device to a second device using the developed protocol, the method comprising:
receiving the data prior to transmission from the first device;
receiving the data as transmitted from the second device;
forwarding the data from the first device to a data comparator;
forwarding the data from the second device to a data comparator; and
receiving results based on a comparison of the data from the first device and the data from the second device.

12. A method for testing a developed protocol based on data transmitted from a first device to a second device using the developed protocol, the method comprising:
receiving a first set of data from a data controller;
receiving a second set of data from a data controller; and
comparing the first set of data and the second set of data,
wherein the first set of data and the second set of data are received using a known protocol and wherein the second set of data is based on data transmitted from the first device to the second device using the developed protocol.

13. The method of claim 12, wherein the step of comparing comprises:
comparing each element in the first set of data to a corresponding element in the second set of data.

14. The method of claim 12, further comprising:
returning a result of the comparison of the first set of data and the second set of data.
